(19) United States
(12) Patent Application Publication
(10) Pub. No.: US 2023/0320290 A1
(43) Pub. Date: Oct. 12, 2023

(54) FARMING METHOD AND ZEOLITE SUBSTRATE

(71) Applicants: PANASONIC FACTORY SOLUTIONS ASIA PACIFIC PTE. LTD., Singapore (SG); NANYANG TECHNOLOGICAL UNIVERSITY, Singapore (SG)

(72) Inventors: Samuel Alexander MORRIS, Germantown, MD (US); Meng Yuan ZHANG, Jurong West (SG); Sharad KHAREL, Choa Chu Kang (SG); Jia Xuan, Marcus HE, Choa Chu Kang (SG); Dong Qiang ZHANG, Jurong West (SG); Mun Ji LOW, Jurong West (SG); Yeng Ming LAM, Choa Chu Kang (SG)

(21) Appl. No.: 18/296,582

(22) Filed: Apr. 6, 2023

Related U.S. Application Data
(60) Provisional application No. 63/327,957, filed on Apr. 6, 2022.

(51) Int. Cl. A01G 24/13

(52) U.S. Cl. CPC A01G 24/13; A01G 2031/006

(57) ABSTRACT

A farming method includes: loading a broad spectrum of plant nutrients into a zeolite substrate; using the loaded zeolite substrate to grow crops for a plurality of cycles; and recycling the used zeolite substrate.

### CROSS-REFERENCE TO RELATED APPLICATION

This application claims the benefit of Provisional Application No. 63/327,957, filed on Apr. 6, 2022, the content of which is incorporated herein by reference in its entirety.

### TECHNICAL FIELD

The present disclosure relates to the technical field of sustainable agriculture and, more particularly, to a farming method and a zeolite substrate.

### BACKGROUND

Sustainable agriculture allows us to produce and enjoy healthy foods without compromising quality of soils. The key to sustainable agriculture is finding the right way to maintain the quality of soils. In particular, ecologically farming in urban setting makes it economically viable, environmentally sound and protect public health.

### SUMMARY

One aspect of the present disclosure provides a farming method. The method includes: loading a broad spectrum of plant nutrients into a zeolite substrate; using the loaded zeolite substrate to grow crops for a plurality of cycles; and recycling the used zeolite substrate.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart illustrating an exemplary farming method according to some embodiments of the present disclosure;

FIG. 2 illustrates plant nutrient absorption over time using mordenite zeolite and EC6 fertilizer according to some embodiments of the present disclosure;

FIG. 3 illustrates plant nutrient absorption over time using clinoptilolite zeolite and EC6 fertilizer according to some embodiments of the present disclosure;

FIG. 4 illustrates plant nutrient absorption over time using New Zealand zeolite and EC6 fertilizer according to some embodiments of the present disclosure;

FIG. 5 illustrates plant nutrient absorption in 24 hours using mordenite zeolite in different EC fertilizer solutions according to some embodiments of the present disclosure;

FIG. 6A and FIG. 6B illustrate plant nutrient absorption in different cycling patterns according to some embodiments of the present disclosure;

FIG. 7 illustrates potassium depletion according to some embodiments of the present disclosure;

FIG. 8 illustrates calcium depletion according to some embodiments of the present disclosure;

FIG. 9 illustrates sterilization effectiveness with various heating temperatures and heating time lengths according to some embodiments of the present disclosure;

FIG. 10 illustrates effectiveness of washing and sterilization according to some embodiments of the present disclosure;

FIG. 11 illustrates sterilization effectiveness measured by yield over multiple crop growing cycles according to some embodiments of the present disclosure;

FIG. 12 illustrates sterilization effectiveness measured by germination over multiple crop growing cycles according to some embodiments of the present disclosure;

FIG. 13 illustrates yield produced by the used/spent zeolite substrate over multiple crop growing cycles according to some embodiments of the present disclosure;

FIG. 14 illustrates yield produced by the used/spent zeolite substrate in large batches over multiple crop growing cycles according to some embodiments of the present disclosure; and

FIG. 15 illustrates a lab setup for sterilizing the used/spent zeolite substrates according to some embodiments of the present disclosure.

### DETAILED DESCRIPTION OF THE EMBODIMENTS

Embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

The present disclosure provides a farming method based on a zeolite substrate. The farming method may be applied to growing plants indoor in limited space. Plant nutrients are preloaded into the zeolite substrate. The loaded zeolite substrate can be used to grow crops for multiple cycles. The plant nutrients are slowly released from the zeolite substrate to feed the crops. In each growing cycle, the crops are exposed to air and light and are periodically watered. After growing the crops for multiple cycles, the plant nutrients contained in the zeolite substrate are depleted. After the plant nutrients are lowered to a certain threshold, the crops can no longer obtain enough nutrients from the zeolite substrate. At that point, the zeolite substrate is recycled through sterilization, washing, and reloading of the plant nutrients. The crops grown by the recycled zeolite substrate are as good as the crops grown by the initial zeolite substrate.

The zeolite substrate contains naturally obtained zeolite. The zeolite substrate further includes additional materials to provide mechanical support for the crops.

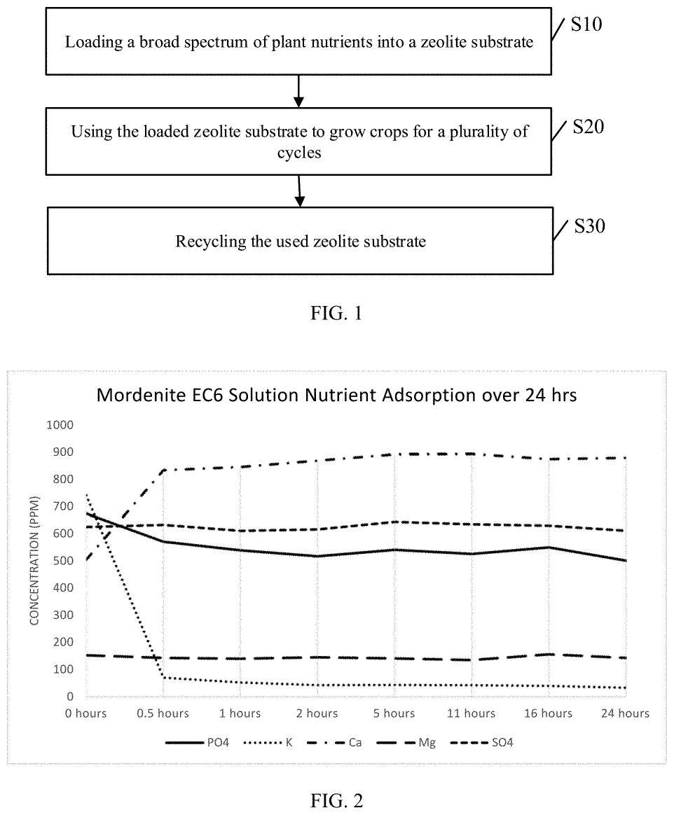

FIG. 1 is a flowchart illustrating an exemplary farming method according to some embodiments of the present disclosure. As shown in FIG. 1, the farming method may include the following processes.

At S10, a broad spectrum of plant nutrients is loaded into a zeolite substrate.

In some embodiments, loading the broad spectrum of plant nutrients into the zeolite substrate includes mixing a fertilizer including the broad spectrum of plant nutrients with the zeolite substrate at a pre-determined volume ratio for a pre-determined time.

In some embodiments, the broad spectrum of plant nutrients includes elements/ions selected from nitrogen (N), boron (B), chlorine (Cl), copper (Cu), iron (Fe), manganese (Mn), molybdenum (Mo), nickel (Ni), zinc (Zn), phosphorus (PO₄), potassium (K), calcium (Ca), magnesium (Mg), sulfate (SO₄), or a combination thereof.

For example, a fertilizer was stirred with 3 different zeolites at a volume ratio of 1:3 (zeolite to fertilizer). The fertilizer used was of known concentration and nutrient contents of the zeolite substrate was measured before and after nutrient loading through X-ray Fluorescence (XRF) spectroscopy. The fertilizer concentration and the structures of zeolites tested were varied.

For example, the fertilizer is Hoagland's solution. Since the fertilizer is in a liquid form, it also called a fertilizer solution. The XRF spectroscopy is used to measure amount of nutrients or fertilizer cations adsorbed by the zeolite substrate. Concentrations of the fertilizer cations in the fertilizer solution are measured before and after the zeolite substrate is submerged in the fertilizer solution. The difference is the amount of plant nutrients that reside within or on surfaces of the Zeolite substrate. In addition, the soaked zeolite substrate is also separately analyzed to obtain a secondary measurement of nutrient adsorption. Solid analysis of the soaked zeolite substrate is performed using QuantExpress on a Bruker S8 Tiger X-ray fluorescence machine. The data shown in tables below provides evidences that the zeolite substrate is successfully loaded with the broad spectrum of plant nutrients.

In one example, the zeolite substrate is submerged in the fertilizer solution. Three types of zeolites are tested are Mordenite, Clinoptilolite, and a Mordenite/Clinoptilolite Mix, referred to as ‘New Zealand’ hence forth. They are submerged in an EC6 fertilizer solution for 24 hours. EC6 stands for electrical conductivity level 6. The EC level is an indication of concentration of plant nutrients. The higher the EC level, the higher the concentration of plant nutrients. The concentrations (in unit of parts per million or PPM) of the plant nutrients are measured and shown in the tables below. Table 1 shows the amounts of plant nutrients remaining in the fertilizer solution, and Table 2 shows the amounts of plant nutrients adsorbed in the zeolite substrate.

TABLE 1

| | Original EC | Mordenite | Clinoptilolite | New Zealand |
|---|---|---|---|---|
| PO4 | 675 | 488 | 530 | 567 |
| K | 742 | 32 | 93 | 92.5 |
| Ca | 506 | 888 | 599 | 363.5 |
| Mg | 153 | 140 | 122 | 254 |
| SO4 | 626 | 612.5 | 621.5 | 621 |

TABLE 2

| | Original EC | Mordenite | Clinoptilolite | New Zealand |
|---|---|---|---|---|
| PO4 | 675 | 187 | 145 | 108 |
| K | 742 | 710 | 649 | 649.5 |
| Ca | 506 | −382 | −93 | 142.5 |
| Mg | 153 | 13 | 31 | −101 |
| SO4 | 626 | 13.5 | 4.5 | 5 |

All three zeolites have a large propensity towards potassium adsorption. Where Mordenite and Clinoptilolite expel calcium, New Zealand expels magnesium, implying those cations are the dominant cations inside the natural zeolite that are exchangeable, or that in the slightly acidic fertilizer solution, MgO or CaO is partially dissolved. This pH dependency has been shown to have minimal effect. There is a clear lack of sulphate adsorption throughout, despite other anions (PO₄) showing adsorption in all three zeolites. This implies that the lack of absorption is sulphate specific and not due to its charge.

The adsorption of each ion does not reflect the ratio found within the original fertilizer solution, showing there is clear preferential adsorption. To optimize the zeolite substrate such that fertilizer nutrient concentration ratios are maintained in the zeolite substrate, multiple zeolites can be mixed, or the fertilizer concentrations changed to account for this preferential adsorption, resulting in the zeolite substrate with a balanced nutrient profile.

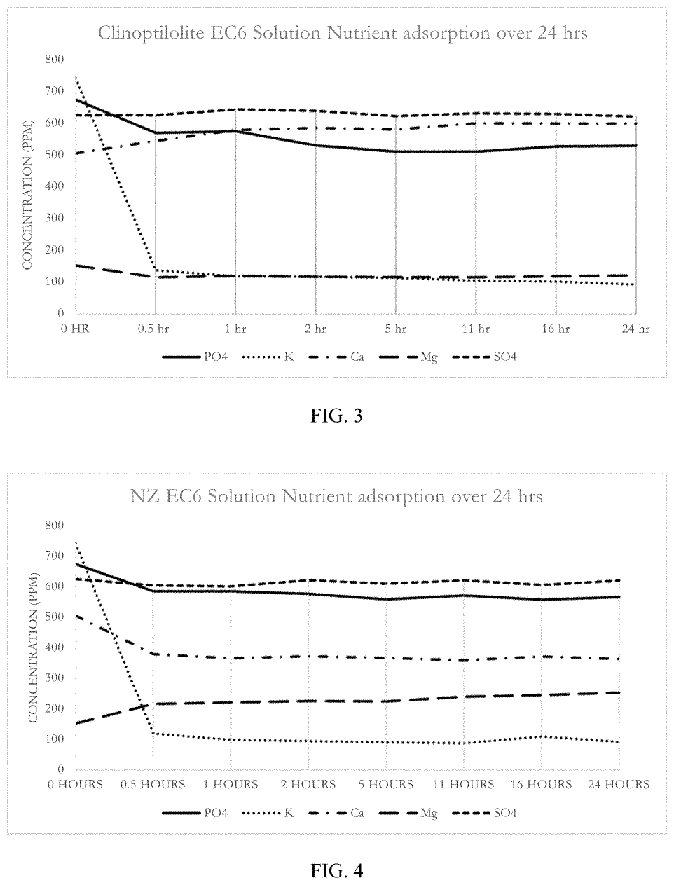

In one example, the zeolite substrate is submerged in the EC6 fertilizer solution for various time lengths to evaluate how quickly the nutrients are adsorbed or exchanged by each type of the zeolites. Table 3 below shows Mordenite zeolite absorption of the EC6 fertilizer solution over a time length of 24 hours. Table 4 below shows Clinoptilolite zeolite absorption of the EC6 fertilizer solution over a time length of 24 hours. Table 5 below shows New Zealand zeolite absorption of the EC6 fertilizer solution over a time length of 24 hours. The data shown in Table 3, Table 4, and Table 5 are depicted in FIG. 2, FIG. 3, and FIG. 4, respectively.

TABLE 3

| Unit = | 0 | 0.5 | 1 | 2 | 5 | 10 | 16 | 24 |
|---|---|---|---|---|---|---|---|---|
| PPM | hours | hours | hours | hours | hours | hours | hours | hours |
| PO4 | 675 | 572 | 540 | 518 | 542 | 421 | 551 | 502 |
| K | 742 | 71 | 53 | 44 | 44 | 39 | 41 | 34 |
| Ca | 506 | 835 | 847 | 870 | 893 | 828 | 876 | 880 |
| Mg | 153 | 144 | 141 | 146 | 142 | 132 | 157 | 143 |
| SO4 | 626 | 634 | 612 | 618 | 645 | 506 | 631 | 612 |

TABLE 4

| Unit = | 0 | 0.5 | 1 | 2 | 5 | 11 | 16 | 24 |
|---|---|---|---|---|---|---|---|---|
| PPM | hours | hours | hours | hours | hours | hours | hours | hours |
| PO4 | 675 | 570.5 | 575.5 | 531 | 528 | 479.5 | 519 | 530 |
| K | 742 | 138 | 119 | 118 | 111.5 | 102 | 99.5 | 93 |
| Ca | 506 | 545.5 | 579.5 | 586 | 603 | 604 | 593.5 | 599 |
| Mg | 153 | 116 | 120 | 117.5 | 119.5 | 115 | 124.5 | 122 |
| SO4 | 626 | 626 | 644 | 639.5 | 641 | 637.5 | 610 | 621.5 |

TABLE 5

| Unit = | 0 | 0.5 | 1 | 2 | 5 | 11 | 16 | 24 |
|---|---|---|---|---|---|---|---|---|
| PPM | Hours | Hours | Hours | Hours | Hours | Hours | Hours | Hours |
| PO4 | 675 | 586 | 586 | 577.5 | 546.5 | 572 | 571.5 | 567 |
| K | 742 | 120 | 99 | 95 | 85.5 | 88 | 125.5 | 92.5 |
| Ca | 506 | 379.5 | 366 | 372.5 | 357 | 359.5 | 376 | 363.5 |
| Mg | 153 | 217 | 222 | 226.5 | 229.5 | 241 | 259 | 254 |
| SO4 | 626 | 605 | 602 | 622 | 601.5 | 621.5 | 617.5 | 621 |

As can be seen from the tables above, Phosphate is adsorbed in a two-step process. The first 30 minutes see rapid adsorption to approximately 50% of its end total. The next 23.5 hours see a slow, gradual further adsorption. Its initial rapid adsorption implies the zeolite has positive sites that favorably bind anions. Normally, these consist of siloxy groups under basic conditions. However, the fertilizer solution is acidic, implying either a secondary source of positive sites for anion binding, impurity binding sites or secondary absorption onto the surface cation monolayer formed from other adsorbed cations. The secondary adsorption could also occur from salt formation within the zeolite pore space over time, with a large amount of positive ions that are adsorbed in the first 30 minutes.

In all types of the zeolites, potassium is adsorbed in the first 30 minutes, with natural fluctuations occurring afterwards as the zeolites seek equilibrium with surroundings thereof.

Calcium behaves differently in each type of the zeolites. Mordenite zeolite shows an expulsion of 374 PPM, clinoptilolite zeolite shows an expulsion of 93 PPM, and New Zealand zeolite adsorbs 142 PPM. As the zeolites show both expulsion and adsorption of calcium, it implies that the effect of CaO dissolution by the slightly acidic fertilizer solution is minimal. However, without confirmation of the stoichiometry of the calcium form in each zeolitic tuff, shown to be 3.2, 2.9 and 1.1 wt % of mordenite, clinoptilolite, and New Zealand respectively, it is difficult to rule out Ca dissolution as an influence. In case of minimal dissolution, the dominant cation held inside natural mordenite and clinoptilolite is calcium, which is expelled by other ions that outcompete calcium cations energetically.

Sulphate is adsorbed extremely poorly throughout, with all adsorption within the calibrated standard deviation of 28 PPM. This means no statistical accuracy can be attributed to the result and it should be discarded. Despite the liquid calibration showing sulphate uptake, analysis of the solid zeolites shows an uptake of nearly 400 PPM across 24 hours in Mordenite, as shown in the table below. This implies that either there is a greater sensitivity to sulphur in the solid form (as these are done under vacuum as opposed to helium, which heavily adsorbs characteristic sulphur X-rays) or the liquid calibration does not fully capture the desired concentration range.

TABLE 6

| Unit = | 0 | 0.5 | 1 | 2 | 5 | 16 | 24 |
|---|---|---|---|---|---|---|---|
| wt % | hours | hours | hours | hours | hours | hours | hours |
| SiO2 | 75.39% | 75.28% | 75.33% | 75.62% | 75.38% | 75.23% | 75.22% |
| AlO2 | 14.19% | 14.05% | 14.03% | 13.81% | 13.98% | 14.09% | 14.06% |
| CaO | 3.22% | 3.13% | 3.16% | 3.16% | 3.13% | 3.14% | 3.11% |
| Fe2O3 | 2.78% | 2.79% | 2.69% | 2.64% | 2.70% | 2.71% | 2.76% |
| K2O | 2.38% | 2.65% | 2.66% | 2.65% | 2.66% | 2.69% | 2.68% |
| Na2O | 1.42% | 1.34% | 1.37% | 1.39% | 1.39% | 1.37% | 1.37% |
| MgO | 0.29% | 0.30% | 0.29% | 0.28% | 0.30% | 0.30% | 0.31% |
| TiO2 | 0.18% | 0.17% | 0.16% | 0.17% | 0.17% | 0.17% | 0.17% |
| PO4 | 0.02% | 0.09% | 0.10% | 0.09% | 0.10% | 0.11% | 0.13% |
| MnO | 0.07% | 0.05% | 0.05% | 0.05% | 0.05% | 0.05% | 0.05% |
| BaO | 0.05% | 0.05% | 0.06% | 0.05% | 0.05% | 0.05% | 0.05% |
| SO4 | 0.01% | 0.05% | 0.06% | 0.05% | 0.05% | 0.05% | 0.05% |

In the following examples, the effect of EC nutrient level on the absorption is discussed.

Changes to the nutrient concentrations, and hence fertilizer EC values, are experimented to understand if nutrient concentration may affect the nutrient uptake values and the ratios thereof. At given values, the zeolite is filled or fully loaded. However, despite testing up to EC10, there are no signs that the zeolite is loaded close to capacity. Field testing, however, shows that with ever increasing EC values, there is a greater risk of nutrient burn to juvenile crops, which negates the enhanced growth rate obtained by increasing nutrient concentrations in the zeolite substrate.

The tables below show how increasing EC (fertilizer solution concentration) increases the amount of nutrient adsorbed in the zeolite substrate, shown as both an amount and as a percentage of the total nutrient that is present in the fertilizer solution. For example, 83.1% of PO₄ for mordenite zeolite means that the amount of 59 PPM represents 83.1% of the total present in the EC6 fertilizer solution. This relates the EC concentration to both efficiency of adsorption and amount adsorbed. Table 7 and Table 8 show the data for mordenite zeolite. Table 9 and Table 10 show the data for clinoptilolite zeolite. Table 11 and Table 12 show the data for New Zealand zeolite.

TABLE 7

| | EC1 | EC2 | EC6 | EC10 |
|---|---|---|---|---|
| PO4 | 59 | 76 | 187 | 305 |
| K | 75 | 228.5 | 710 | 1274 |
| Ca | −33 | −113.5 | −382 | −629.5 |
| Mg | 12 | 3.5 | 13 | 0.5 |
| SO4 | −2 | −1 | 13.5 | 24.5 |

TABLE 8

| | EC1 | EC2 | EC6 | EC10 |
|---|---|---|---|---|
| PO4 | 83.1% | 37.8% | 27.7% | 24.1% |
| K | 100.0% | 98.9% | 95.7% | 93.8% |
| Ca | −57.9% | −71.8% | −75.5% | −69.1% |
| Mg | 42.9% | 7.6% | 8.5% | 0.2% |
| SO4 | −2.4% | −0.5% | 2.2% | 2.2% |

TABLE 9

| | EC1 | EC2 | EC6 | EC10 |
|---|---|---|---|---|
| PO4 | 26 | 33 | 145 | 209 |
| K | 58 | 204 | 649 | 1164 |
| Ca | 28 | 22 | −93 | −298 |
| Mg | 20 | 16 | 31 | 8 |
| SO4 | −6 | −2 | 5 | −26 |

TABLE 10

| | EC1 | EC2 | EC6 | EC10 |
|---|---|---|---|---|
| PO4 | 37% | 16% | 21% | 16% |
| K | 90% | 88% | 87% | 86% |
| Ca | 49% | 14% | −18% | −33% |
| Mg | 71% | 35% | 20% | 3% |
| SO4 | −7% | −1% | 1% | −2% |

TABLE 11

| | EC1 | EC2 | EC6 | EC10 |
|---|---|---|---|---|
| PO4 | 52.5 | 64 | 108 | 200.5 |
| K | 65 | 214.5 | 649.5 | 1172 |
| Ca | 50.5 | 108.5 | 142.5 | 106 |
| Mg | −6 | −37 | −101 | −158 |
| SO4 | 3 | −2.5 | 5 | 30 |

TABLE 12

| | EC1 | EC2 | EC6 | EC10 |
|---|---|---|---|---|
| PO4 | 74% | 32% | 16% | 16% |
| K | 87% | 93% | 88% | 86% |
| Ca | 89% | 69% | 28% | 12% |
| Mg | −21% | −80% | −66% | −60% |
| SO4 | 4% | −1% | 1% | 3% |

In general, all three zeolites show decreasing adsorption efficiency with increasing EC value, despite a larger amount of each nutrient being adsorbed or desorbed.

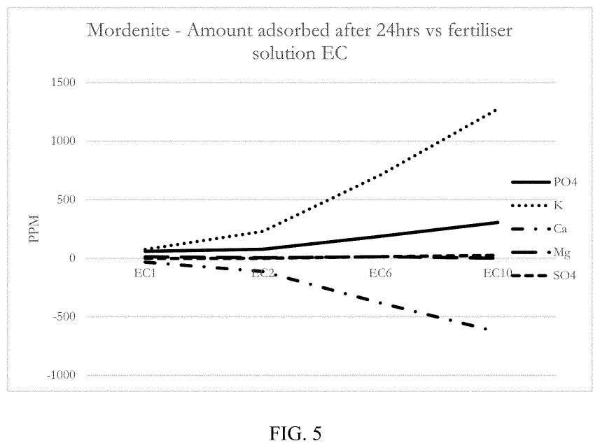

As shown in FIG. 5, mordenite zeolite shows consistent trends. As EC values increase, the amount adsorbed or emitted by mordenite zeolite either increases or decreases respectively, showing no signs of plateauing at high EC values. This implies that a full adsorption amount has not yet been reached.

Clinoptilolite zeolite shows similar trends to mordenite zeolite. Apart from with Ca, where at low EC values, it adsorbs calcium (EC1=28 PPM), but quickly emits large amounts of Ca at high EC values (EC10=−298 PPM). New Zealand zeolite shows similar trends to mordenite but expels magnesium instead of calcium to greater amounts as EC increases.

In the following examples, differences between different types of zeolites are discussed.

Tables 13-16 shows reorientated information from Tables 7-12, allowing the direct comparison between different types of zeolites across various EC values. It should be noted that potassium is highly selected for across all zeolites, at all EC values, whilst SO4 is never selected for and shows statistically insignificant results.

TABLE 13

| | | | New |
|---|---|---|---|
| | Mordenite | Clinoptilolite | Zealand |
| PO4 | 83% | 37% | 74% |
| K | 100% | 90% | 87% |
| Ca | −58% | 49% | 89% |
| Mg | 43% | 71% | −21% |
| SO4 | −2% | −7% | 4% |

TABLE 14

| | | | New |
|---|---|---|---|
| | Mordenite | Clinoptilolite | Zealand |
| PO4 | 38% | 16% | 32% |
| K | 99% | 88% | 93% |
| Ca | −72% | 14% | 69% |
| Mg | 8% | 35% | −80% |
| SO4 | 0% | −1% | −1% |

TABLE 15

| | | | New |
|---|---|---|---|
| | Mordenite | Clinoptilolite | Zealand |
| PO4 | 28% | 21% | 16% |
| K | 96% | 87% | 88% |
| Ca | −75% | −18% | 28% |
| Mg | 8% | 20% | −66% |
| SO4 | 2% | 1% | 1% |

TABLE 16

| | | | New |
|---|---|---|---|
| | Mordenite | Clinoptilolite | Zealand |
| PO4 | 24% | 16% | 16% |
| K | 94% | 86% | 86% |
| Ca | −69% | −33% | 12% |
| Mg | 0% | 3% | −60% |
| SO4 | 2% | −2% | 3% |

TABLE 17

| | Mean Ion-Water | Ionic Radii |
|---|---|---|
| | Internuclear | (solution) |
| Ion | distance (nm) | (nm) |
| Na+ | 0.2356 ± 0.0060 | 0.097 ± 0.006 |
| K+ | 0.2798 ± 0.0081 | 0.141 ± 0.008 |
| NH4+ | 0.331* | 0.148* |
| Mg2+ | 0.2090 ± 0.0041 | 0.070 ± 0.004 |
| Ca2+ | 0.2422 ± 0.0052 | 0.103 ± 0.005 |
| Mn2+ | 0.2192 ± 0.0013 | 0.080 ± 0.001 |
| Fe2+ | 0.2114 ± 0.0010 | 0.072 ± 0.001 |
| Cu2+ eq | 0.1968 ± 0.0047 | |
| Cu2+ ax | 0.240 ± 0.010 | |
| Cu2+ mean | 0.211 | |
| Zn2+ | 0.2098 ± 0.0066 | 0.070 ± 0.007 |
| Al3+ | 0.1887 ± 0.0015 | 0.050 ± 0.002 |
| Fe3+ | 0.2031 ± 0.0019 | 0.064 ± 0.002 |
| Cl− | 0.3187 ± 0.0067 | 0.180 ± 0.007 |
| NO3-ax | 0.265 | |
| NO3-eq | 0.3451 ± 0.0043 | |
| NO3-mean | 0.316 ± 0.002 | 0.177 ± 0.002 |
| H2PO4− | 0.377 ± 0.011 | 0.238 ± 0.011 |
| SO42− | 0.3815 ± 0.0071 | 0.242 ± 0.007 |

Structurally, mordenite zeolite has 8 and 12 rings. The 12 ring is 6.5×7.0 Å that are connected by smaller 2.6×5.7 Å tortuous channels. This arrangement leads to a small port problem and issues such as natural mordenite zeolite not being able to accept cations larger than ˜4.5 Å. Most aluminum T atoms are found in the T3 structural site, located on the wall of the oval 8 ring, resulting in most cations residing near this site in the mordenite zeolite structure.

Clinoptilolite zeolite has three intersecting channels, two parallel to the c-axis, one 10 ring, oval-shaped channel measuring 3.0×7.6 Å (channel A), and one 8 ring channel measuring 3.3×4.6 Å (Channel B). Parallel to the a-axis is a further 8 ring channel of 2.6×4.7 Å (Channel C). It has 3 main cation sites internally, a first site at the intersection of the A and C channels, a second site within channel B that mostly contains Ca and rarely Na, and a third site in channel C where K is favored. It has been shown in Clinoptilolite zeolite that cations typically bind to framework oxygens and multiple water molecules that reside in the channels, simultaneously, hence it is propensity for high water storage and drought tolerance.

Calculated hydrated and ionic radii in Table 17 (All values taken from reference 1 unless *, which was taken from reference 2). show that no ion of interest is too large to fit in any of our chosen zeolites. Steric size is only one component of adsorption however, with hydration energy and stabilization being important factors. Ones that without lengthy computational studies are very difficult to probe theoretically due to the complex interaction in the multi-ion fertilizer solution. There is a clear preference for low charge density, small (1-1.4 Å) radii ions such as potassium, and a lack of adsorption for larger anions and small, high density cations.

In the following examples, correlation between liquid zeolite analysis and solid zeolite analysis is discussed.

It is found that potassium is adsorbed preferentially in all three zeolites, with Ca being emitted in both mordenite zeolite and clinoptilolite zeolite, whilst Mg is emitted from New Zealand zeolite. Mg and SO₄ are poorly adsorbed across all three zeolites. Time studies show that most adsorption occurs within the first 30 minutes and that increasing EC solution values increases the amount of any element adsorbed or emitted, but does little to change Mg levels within clinoptilolite zeolite and mordenite zeolite. No limit is observed on the amount adsorbed, with there being no plateau in adsorption of any element when tested up to a strength of EC 10. What remains to be understood is how calibrated liquid tests fare against the solid analysis of the zeolite.

Correlation between the solid uptake of nutrients and those observed from the calibrated liquid testing is described in the tables below. Table 18 shows the solid analysis of mordenite zeolite soaked in EC 6 solution, with samples taken at designated times. Table 19 shows the average 24 hr change (24 hr—0 hr value) compared to the 24hr change shown through calibrated liquid analysis.

TABLE 18

| Unit = | 0 | 0.5 | 1 | 2 | 5 | 16 | 24 |
|---|---|---|---|---|---|---|---|
| wt % | hours | hours | hours | hours | hours | hours | hours |
| SiO2 | 75.39% | 75.28% | 75.33% | 75.62% | 75.38% | 75.23% | 75.22% |
| AlO2 | 14.19% | 14.05% | 14.03% | 13.81% | 13.98% | 14.09% | 14.06% |
| CaO | 3.22% | 3.13% | 3.16% | 3.16% | 3.13% | 3.14% | 3.11% |
| Fe2O3 | 2.78% | 2.79% | 2.69% | 2.64% | 2.70% | 2.71% | 2.76% |
| K2O | 2.38% | 2.65% | 2.66% | 2.65% | 2.66% | 2.69% | 2.68% |
| Na2O | 1.42% | 1.34% | 1.37% | 1.39% | 1.39% | 1.37% | 1.37% |
| MgO | 0.29% | 0.30% | 0.29% | 0.28% | 0.30% | 0.30% | 0.31% |
| TiO2 | 0.18% | 0.17% | 0.16% | 0.17% | 0.17% | 0.17% | 0.17% |
| PO4 | 0.02% | 0.09% | 0.10% | 0.09% | 0.10% | 0.11% | 0.13% |
| MnO | 0.07% | 0.05% | 0.05% | 0.05% | 0.05% | 0.05% | 0.05% |
| BaO | 0.05% | 0.05% | 0.06% | 0.05% | 0.05% | 0.05% | 0.05% |
| SO4 | 0.01% | 0.05% | 0.06% | 0.05% | 0.05% | 0.05% | 0.05% |

TABLE 19

| Average 24 hr | | | 24 hr Change |
|---|---|---|---|
| Change (Solid) | | | (Liquid) |
| wt % | PPM | Compound | PPM |
| −0.17% | −1700 | SiO2 | |
| −0.12% | −1250 | AlO2 | |
| −0.11% | −1100 | CaO | −382 |
| −0.02% | −200 | Fe2O3 | |
| 0.31% | 3050 | K2O | 710 |
| −0.05% | −500 | Na2O | |
| 0.02% | 200 | MgO | 13 |
| −0.01% | −100 | TiO2 | |
| 0.11% | 1050 | PO4 | 187 |
| −0.02% | −200 | MnO | |
| 0.04% | 400 | SO4 | 13.5 |

Whilst the correct adsorption direction is confirmed, i.e. the absorption in the solid zeolite is reflected in the liquid, as is emission, the absolute values do not match. There are multiple effects which obscure these observations and make it difficult to draw conclusions. In the solid form, the major form of each element is the oxide, whilst in the liquid form, each element is the ionic form. Hence the wt % is different and it is difficult to compare.

Returning to FIG. 1, at S20, the loaded zeolite substrate is used to grow crops for a plurality of cycles.

In the examples described below, growing the crops for the plurality of cycles includes two cycling patterns and three cycles. The two cycling patterns are a continuous growth pattern and a shaken pattern.

In the continuous growth pattern, after each cycle, the mature plant is plucked at the stem and a new seed is planted next to the stem site. The advantages of this method include that labor demands are decreased significantly and the microbiome within the zeolite is left undisturbed, thereby encouraging growth, especially of fungal systems that often die upon heavy disturbance of the soil or the zeolite substrate in this case. However, by not disturbing the zeolite substrate and having a weak microbial content, compaction easily occurs and the zeolite possessing greater nutrient density is further away from the seedling and is not accessible until mature roots are grown.

The shaken pattern involves the zeolite substrate being shaken and mixed after each cycle, thereby breaking apart compaction, homogenizing the nutrient dense and nutrient poor zeolite, and dispersing any organic root components from the previous cycle. The new seed is then deposited in the center of the zeolite substrate and the next cycle ensues. This method involves considerable labor cost and stands to destroy any fungal components of the microbiome. This cycling pattern results in significantly better long-term plant growth, as cycle 2 and cycle 3 show larger plants and better germination rates over counterparts in the continuous growth pattern.

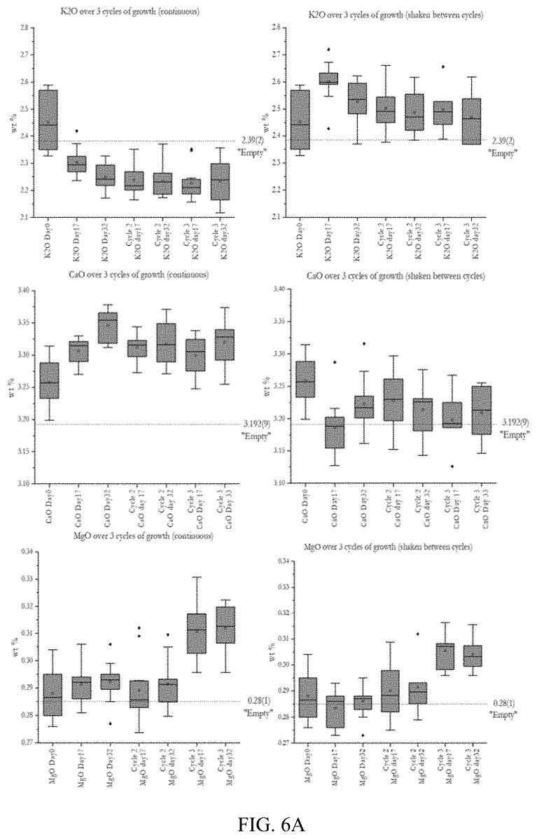

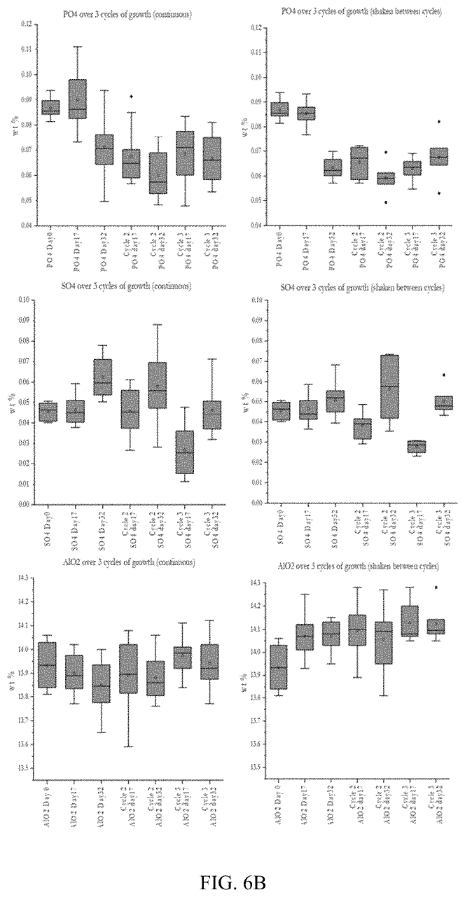

As shown in FIG. 6A and FIG. 6B, both the continuous growth trials and the shaken trials display similar nutrient change trends, but there are obvious differences in the scales of those trends. The shaken trials show small deviation between cycles as is expected as the zeolite substrate is homogenized after each cycle, as opposed to the continuous growth trials whereby the nutrients are expected to be less homogenous, with higher nutrient density found at the edge of the zeolite substrate and progressively depleting nutrient contents as approaching the center and the axis of root growth. The element specific trends are discussed below.

Potassium displays two clear trends. When the continuous growth cycles are conducted, potassium decreases in concentration incrementally with each datapoint, tailing off rapidly over 2 cycles to plateau. This means the potassium reserves have been exhausted locally to the central axis of the zeolite substrate where planting and testing occur. When shaken and homogenized between cycles, it is observed that potassium levels remain at or above the initial treatment amount throughout the three cycles tested. This implies that potassium is being gradually released from the zeolite in the vicinity of root growth, but not so from the outer edges of the zeolite substrate that have little root zone contact. It proves the zeolite substrate acts as a slow-release, long term nutrient storage substrate for plant growth. Further cycles show how long that reserve lasts before potassium becomes a growth limiting factor.

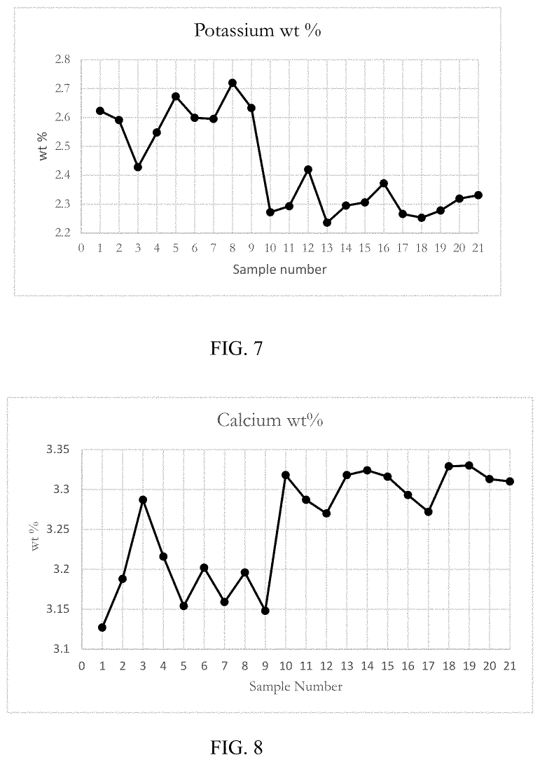

Upon inspection of the potassium data however concerning trends have been observed. 21 samples are taken from 56 pots for the day 17 of cycle one as shown in Table 20 below. Table 20 includes potassium wt % measured as K₂O. Table 20 shows a decline in potassium that is associated with production irregularities when mixing the fertilizer with zeolite without mixing. The data in Table 20 is from Day 17 of cycle 1. During that time all zeolite substrates are treated equally, and no bias is formed in watering or treatment from zeolite substrates 1 to 56. However, data shows that potassium content decreased from an average of ˜2.6 wt % in low sample numbers (1-10) to around 2.3 wt % in high sample numbers (15-21) as shown in FIG. 7. This may arise from the lack of stirring when creating the zeoponic mixtures, encouraging inhomogeneous adsorption. If multiple bags are used to create the zeoponic mixtures, it may also be that fertilizer concentrations are made up inconsistently, causing a discrepancy that results in two separate levels of adsorption into the zeolite substrate.

TABLE 20

| | Potassium |
|---|---|
| Sample | wt % |
| 1 | 2.623 |
| 2 | 2.591 |
| 3 | 2.428 |
| 4 | 2.548 |
| 5 | 2.673 |
| 6 | 2.599 |
| 7 | 2.595 |
| 8 | 2.72 |
| 9 | 2.633 |
| 10 | 2.272 |
| 11 | 2.293 |
| 12 | 2.42 |
| 13 | 2.236 |
| 14 | 2.295 |
| 15 | 2.306 |
| 16 | 2.372 |
| 17 | 2.266 |
| 18 | 2.253 |
| 19 | 2.278 |
| 20 | 2.319 |
| 21 | 2.331 |

Due to this discrepancy between starting values, the data is tracked from substrate-to-substrate within each cycle and the change in potassium wt % investigated for both shaken and continuous growth trials. The data in Table 22 shows that there is large drop in potassium content during the first cycle (indicated by negative values in the table) for both continuous growth and shaken. Thereafter during cycles 2 and 3, the continuous growth trials display minimal potassium loss during cycles, whereas the shaken trials show continued, larger potassium losses owing to the rehomogenation of the zeolite substrate between cycles.

Calcium shows a consistent increase in concentration between day 17 and day 32, as seen in Table 21. Table 21 includes calcium wt % measured as CaO. The data in Table 21 is from Day 17 of cycle 1. The shaken trials during cycle 2 are an outlier, where a small loss in Ca is observed. It should be noted how the continuous growth trials display a higher average Ca content than the shaken trials. This can be understood by the repeated watering centering on the plant root axis down the center of the zeolite substrate, building up Ca along that axis, where the continuous growth trials leave this process undisturbed to accumulate.

TABLE 21

| | Calcium |
|---|---|
| Sample | wt % |
| 1 | 3.127 |
| 2 | 3.188 |
| 3 | 3.287 |
| 4 | 3.216 |
| 5 | 3.154 |
| 6 | 3.202 |
| 7 | 3.159 |
| 8 | 3.196 |
| 9 | 3.148 |
| 10 | 3.318 |
| 11 | 3.287 |
| 12 | 3.27 |
| 13 | 3.318 |
| 14 | 3.324 |
| 15 | 3.316 |
| 16 | 3.293 |
| 17 | 3.272 |
| 18 | 3.329 |
| 19 | 3.33 |
| 20 | 3.313 |
| 21 | 3.31 |

Multiple factors may affect Ca concentration. The tap water used contains 23 PPM of Ca, hence an increase in watering between day 17 and day 32 may account for its overall increase as Ca is adsorbed by the zeolite substrate to offset the emission of other nutrients. Ca may also be buffered by the inherent Ca containing materials within the zeolite substrate, such as CaCO₃ and CaO, that become available as Ca decreases below a certain threshold or is activated by changes in pH. As the Ca forms change, so too would the XRF assumptions on Ca content. In this case, the bulk is CaO. Changes to the flux of Ca would alter that assumption, potentially making the measurement unreliable.

Calcium displays the opposite trend to potassium, in that lower sample number have a smaller average Ca content, whereas higher sample numbers contain larger Ca amounts as shown in Table 21 and FIG. 8. This supports the idea discussed previously of stirring being required when loading zeolite with plant nutrients or fertilizer to ensure homogenous distribution.

As shown in all previous examples, the magnesium uptake is very slow and hence minimal uptake throughout all trials is observed. There is however a consistent, statistically relevant increase in the magnesium content for both the continuous growth and the shaken trials between cycle 2 and 3 in FIG. 6A and FIG. 6B. This indicates a change in experimental procedure or external influence on the zeolite substrate, as all testing methods are constant and many data points back up this observation.

Phosphate decreases rapidly in both the continuous growth and the shaken trials, implying it is rapidly taken up by the plant and potentially the limiting factor in growth. Both trials decrease to around 0.05 wt % PO₄, which is close to the level of phosphorus typically found in native zeolite. The rapid decrease may also be attributed to the lack of strong adsorption by the zeolite, whereby weakly-bound anions may be quickly dissolved and removed by regular watering. However, as all cycles, bar shaken cycle 3, show a substrate-to-substrate decrease. It is assumed that the plant uptake is the main destination for phosphate as shown in Table 22. Table 22 is a summary of nutrient changes in-cycle, which is calculated by taking the nutrient value of day 32 away from day 17 of the same cycle. All values are in PPM.

TABLE 22

| | CaO | CaO | CaO | K2O | K2O | K2O |
|---|---|---|---|---|---|---|
| | Cycle 1 | Cycle 2 | Cycle 3 | Cycle 1 | Cycle 2 | Cycle 3 |
| PPM | Change | Change | Change | Change | Change | Change |
| Shaken | 387 | −140 | 107 | −830 | −160 | −288 |
| Change | | | | | | |
| Continuous | 395 | 53 | 203 | −539 | −28 | 81 |
| Change | | | | | | |
| | MgO | MgO | MgO | PO4 | PO4 | PO4 |
| | Cycle 1 | Cycle 2 | Cycle 3 | Cycle 1 | Cycle 2 | Cycle 3 |
| PPM | Change | Change | Change | Change | Change | Change |
| Shaken | 25 | 14 | −14 | −249 | −65 | 47 |
| Change | | | | | | |
| Continuous | 9 | 24 | 12 | −191 | −75 | −18 |
| Change | | | | | | |
| | SO4 | SO4 | SO4 | AlO2 | AlO2 | AlO2 |
| | Cycle 1 | Cycle 2 | Cycle 3 | Cycle 1 | Cycle 2 | Cycle 3 |
| PPM | Change | Change | Change | Change | Change | Change |
| Shaken | 57 | 183 | 225 | −233 | −367 | −33 |
| Change | | | | | | |
| Continuous | 160 | 122 | 197 | −500 | −108 | −333 |
| Change | | | | | | |

Returning to FIG. 1, at S30, the used zeolite substrate is recycled.

The zeolite substrate can be recycled after crop harvest through sterilization, washing and reloading. The recycled or renewed zeolite substrate can be used for further crop growth. Recycling the used zeolite substrate includes washing the zeolite substrate to remove debris and contaminants (e.g., leaves, roots, etc.) from the zeolite substrate, heating the zeolite substrate to a pre-determined temperature and stirring for a pre-determined sterilization time, and reloading the broad spectrum of plant nutrients into the zeolite substrate.

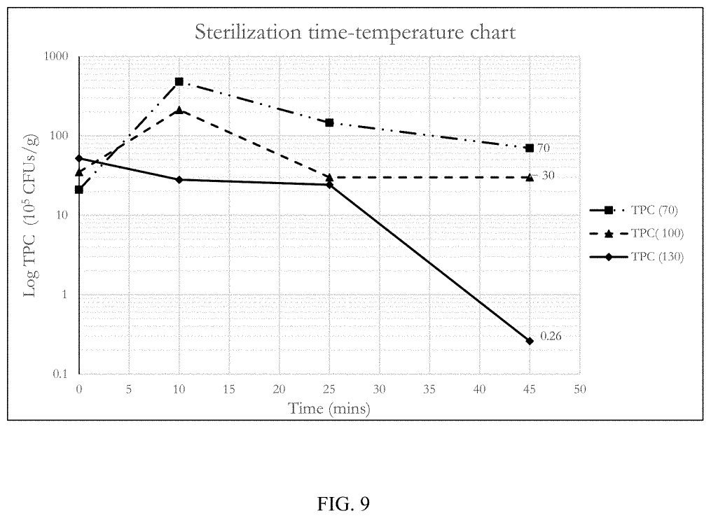

In some embodiments, the used zeolite substrate is heated to about 130° C. and remains at the 130° C. temperature for at least 45 minutes. Thus, bacteria can be removed from the used zeolite substrate. Sterilization efficacy is verified through a bacterial count measurement. As shown in FIG. 9, a total bacterial plate count (TPC) measured at the zeolite substrate varies with heating temperature and heating time. The heating temperature is indicated as “TPC (X)” in the legend, where X=70° C., 100° C., and 130° C., respectively. A lower TPC value means lower bacterial colonies. FIG. 9 shows that the heating temperature 130° C. decreases the TPC across all timescales. Lower temperatures produce large TPC counts until 10 minutes. This is attributed to the slow diffusion of heat through the zeolite resulting in temperature gradients that may initially favor bacterial growth before equilibrium is reached and bacterial apoptosis occurs.

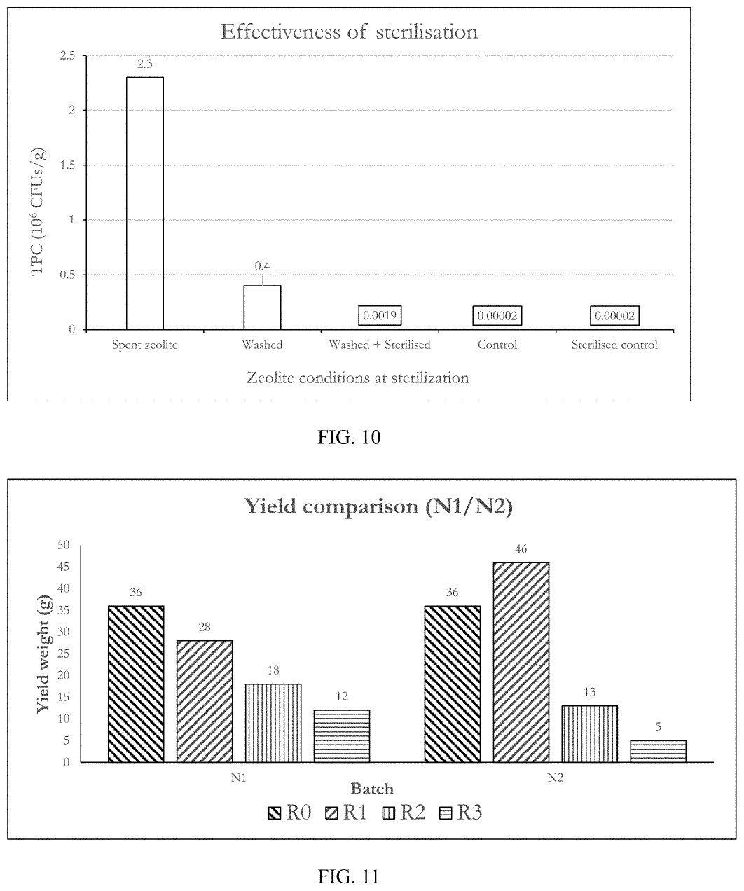

To evaluate the effect of sterilization on the used (or spent) zeolite substrate, as shown in FIG. 10, the TPC values are measured at various stages of the recycling process and compared with a control, that is, a pristine mordenite zeolite from storage.

In some embodiments, a constant flow of hot water is used to wash the used zeolite substrate for about three minutes. The zeolite substrate is filtered through a stainless-steel filter to retain the zeolite while the debris and contaminants are washed away.

As shown in FIG. 10, washing reduces the bacterial count substantially from 2.3 to 0.4 10⁶ CFUs/g, sterilization further lowers the bacterial count to 0.0019 10⁶ CFUs/g, which is a total reduction of 99.92% from the spent zeolite substrate.

In some embodiments, after the used zeolite substrate is washed and sterilized, the used zeolite substrate is submerged in the fertilizer solution to reload plant nutrients. The fertilizer solution has a level of EC 6.0.

To confirm the effects of sterilization on plant growth, the yield and germination rates of “N1”, “N2” and “EC6.0J”, “EC6.0J, L” batches are compared. The crop grown in these batches are Lactuca sativa. The used zeolite substrate is recycled either without (“N1”) or with sterilization (“N2”, “EC6.0J” and “EC6.0J, L” and EC56.), and then seeded to grow crops. Washing and reloading are omitted for the N1/N2 batches but are included for the rest to isolate the effect of the 3 stages of the treatment procedure on plant growth. Greater yields and higher germination rates are desired for industrial application. These conditions are summarized in Table 23. The sample sizes of the batches vary as the number of recycles increased due to medium loss after recycling. These are also reflected in Table 23 as “X/Y/Z/etc.” where X, Y, Z and etc. are the sample sizes while the “/” denotes the recycle stage.

TABLE 23

| Batch | | | | No. of | Sample |
|---|---|---|---|---|---|
| name | Washed | Sterilized | Reloaded | Recycles | sizes |
| N1 | No | No | No | 3 | 7/6/4 |
| N2 | No | Yes | No | 3 | 7/6/6 |
| EC6.0J | Yes | Yes | Yes | 6 | |
| EC6.0J, L | Yes | Yes | Yes | 2 | |

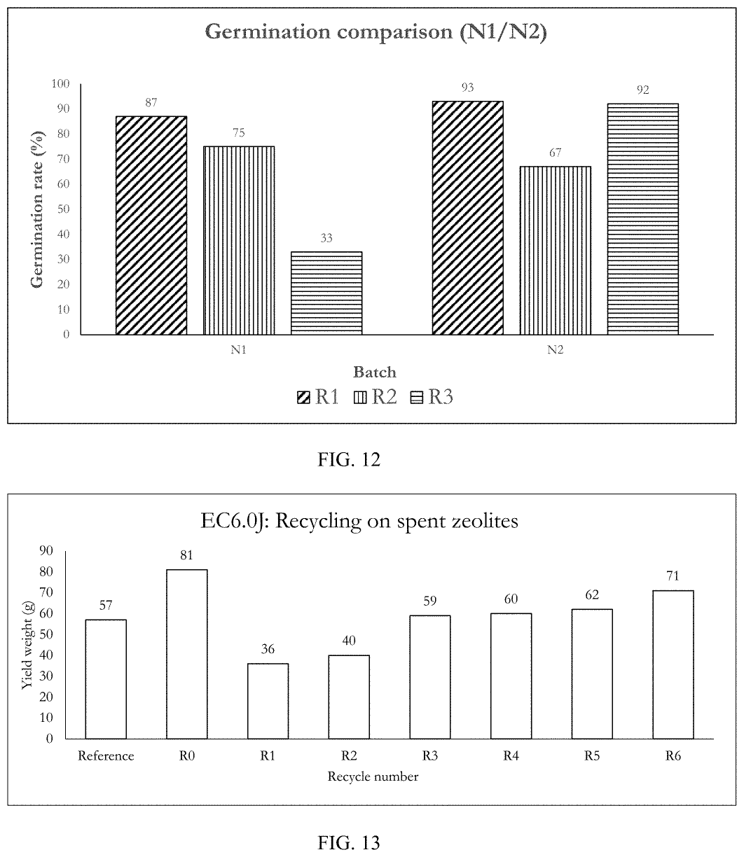

FIG. 11 shows comparisons of yield weights between N1 and N2. FIG. 12 shows comparisons of germination rates between N1 and N2. R0 represents the first cultivation cycle (i.e., on pristine zeolite), while R1-R6 is the recycle number (i.e., nth recycle).

FIG. 11 depicts that sterilization has short term, positive effect on yield, drastically increasing yield for 1 cycle (R2) before large negative effect takes over as shown by the drastic yield drop off from 46 g in R2 to 13 g and 5 g in R3 and R4. This is compared to the slower, constant drop in yield from the non-sterilized spent zeolite substrate.

Germination rates followed similar, inconclusive trends to germination. Non-sterilized zeolite germination rates continually decrease as expected however sterilized zeolites show initially decreasing rates before a drastic, unexpected increase from 67% to 92%.

Both yield and germination rates show that across multiple cycles of growth, the effects of washing and sterilization are inconclusive, however, when just the first recycle is analyzed (R2), sterilization has a very positive effect on yield and a comparable decrease in germination rate compared to the first cycle (R1).

Following the treatment procedure described earlier, the spent/used zeolite substrate is recycled to grow crops. The yields are recorded and shown in FIG. 13. FIG. 13 shows yield weights crops grown in recycled zeolites over many cycles.

As shown in FIG. 13, it can be seen that the used zeolite substrate can be washed, sterilized, and reloaded, then recycled to grow the crops for many cycles. Though the data is available only until the 6^{th} recycle, there is no evidence to show that the recycled zeolite substrate loses efficacy beyond the 6^{th} recycle. The consistent improvement in growth could be attributed to increasing organic matter on the zeolite substrate.

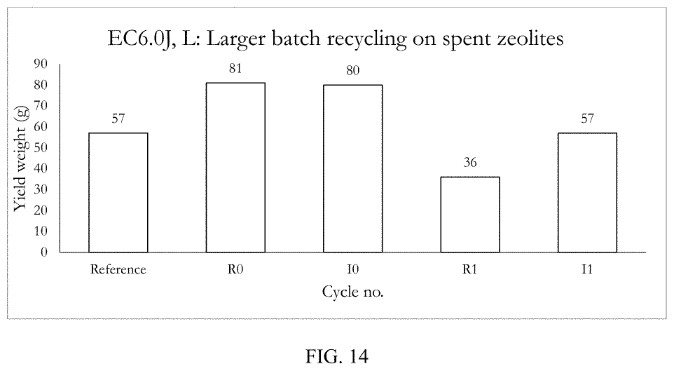

A larger batch of plants, called “EC6.0J, L”, has been used to evaluate the repeatability of the crop growth. FIG. 14 shows yield weights of larger batches to observe repeatability. Instead of “R”, the recycle number is designated using “I”. As shown in FIG. 14, data is available only until I1. It can be observed that this batch is able to achieve the same or better weight as compared with “EC6.0J”.

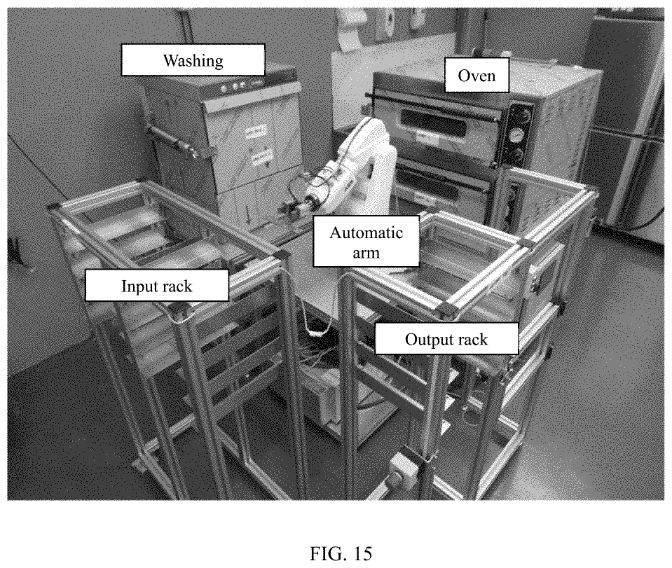

The sterilization of the used zeolite substrate can be carried out using an automatic setup as shown in FIG. 15. As shown in FIG. 15, an automatic arm takes the used/spent zeolite substrate from an input rack, deposits it in the washing machine to wash. After 3 minutes of washing, the used/spent zeolite substrate is taken out from the washing machine and placed into the oven to be heated at 130° C. for 45 minutes. After the sterilization, the sterilized zeolite substrate is placed onto the output rack for use in plant growth.

In some embodiments, the zeolite substrate includes zeolites and sands. The zeolites adsorb the plant nutrients and slowly release the plant nutrients to grow the crops for multiple growth cycles. The sands provide the mechanical support for the crops. The volume ratio of the zeolites in the zeolite substrate is not limited by the present disclosure. When the volume ratio of the zeolites is high, more plant nutrients can be adsorbed and the zeolite substrate can be used to grow the crops for more cycles. When the volume ratio of the zeolites is low, less plant nutrients can be adsorbed and the zeolite substrate can be used to grow the crops for less cycles.

In the embodiments of the present disclosure, using the zeolite substrate to grow the crops eliminates the need for feeding the fertilizer. The plant nutrients adsorbed in the zeolite substrate are slowly released to feed the crops. After the zeolite substrate is used for multiple crop cycles, the used/spent zeolite substrate can be recycled. The recycled zeolite substrate is reloaded with the plant nutrients. Thus, the zeolite substrate is reused to reduce the overall cost of the crop growing and the disposables are minimized.

The above description of the disclosed embodiments enables those skilled in the art to implement or use this application. Various modifications to these embodiments will be obvious to those skilled in the art, and the general principles defined herein can be implemented in other embodiments without departing from the spirit or scope of the present application. Therefore, this application will not be limited to the embodiments shown in the specification, but should conform to the broadest scope consistent with the principles and novelties disclosed in the specification.

What is claimed is:

1. A farming method comprising:
loading a broad spectrum of plant nutrients into a zeolite substrate;
using the loaded zeolite substrate to grow crops for a plurality of cycles; and
recycling the used zeolite substrate.

2. The farming method according to claim 1, wherein loading the broad spectrum of plant nutrients into the zeolite substrate includes:
mixing a fertilizer including the broad spectrum of plant nutrients with the zeolite substrate at a pre-determined volume ratio for a pre-determined time.

3. The farming method according to claim 2, wherein:
the broad spectrum of plant nutrients includes elements/ions selected from N, B, Cl, Cu, Fe, Mn, Mo, Ni, Zn, PO₄, K, Ca, Mg, SO₄, or a combination thereof.

4. The farming method according to claim 1, wherein growing each of the plurality of cycles of plants includes:
planting seeds of a plant in the zeolite substrate;
periodically watering and exposing the seeded zeolite substrate to air and light source; and
harvesting the plant.

5. The farming method according to claim 4, further including:
loosening the zeolite substrate between each of the plurality of cycles of plants.

6. The farming method according to claim 1, wherein recycling the used zeolite substrate includes:
washing the used zeolite substrate to remove debris and contaminants from the used zeolite substrate;
sterilizing the used zeolite substrate; and
reloading the broad spectrum of plant nutrients into the used zeolite substrate.

7. The farming method according to claim 6, wherein washing the used zeolite substrate includes:
washing the used zeolite substrate by a constant flow of hot water for about three minutes.

8. The farming method according to claim 6, wherein sterilizing the used zeolite substrate includes:
heating the used zeolite substrate to about 130° C. and maintains the temperature for at least 45 minutes.
